(19) United States
(12) Patent Application Publication
(10) Pub. No.: US 2013/0259688 A1
(43) Pub. Date: Oct. 3, 2013

(54) PITCH LOCK SYSTEM

(71) Applicant: ENVISION ENERGY (DENMARK) APS, Silkeborg (DK)

(72) Inventor: Carsten Bendix Sørensen, Hojbjerg (DK)

(73) Assignee: ENVISION ENERGY (DENMARK) APS, Silkeborg (DK)

(21) Appl. No.: 13/800,168

(22) Filed: Mar. 13, 2013

(30) Foreign Application Priority Data
Mar. 29, 2012 (DK) PA 2012 70156

(51) Int. Cl. B64C 11/32

(52) U.S. Cl. CPC B64C 11/32
USPC 416/1; 416/153

(57) ABSTRACT

A pitch lock system for a wind turbine with a rotor, at least one pitchable blade and a interface having a pitch bearing system with a first bearing ring, a second bearing ring and a pitch drive installed at a support plate at a structural part connected to the first bearing ring and interacting with teeth on a toothed element, where the toothed element is in fixed connection with the second bearing part. The pitch lock system has at least a base plate and an arrangement for fastening the base plate indirectly to the first bearing ring and a locking pawl that can be fasten to the base plate with an element on the locking pawl interacting with the toothed element.

### BACKGROUND OF THE INVENTION

1. Field of the Invention

The present invention relates to a pitch lock system for a wind turbine with a rotor, the rotor comprising at least one pitchable blade, the at least one pitchable blade being connected to the rotor at an interface or being at least one partial pitch blade, the at least one partial pitch blade comprising an outer blade part and an inner blade part, where the blade parts are interconnected at an interface, the interface comprising a pitch bearing system comprising a first bearing ring, a second bearing ring and a pitch drive, the pitch drive being installed at a support plate at a structural part, the structural part being connected to the first bearing ring, the pitch drive comprising means for interacting with at least two of a number of teeth on a toothed element, where the toothed element is in fixed connection with the second bearing ring, the pitch bearing system being arranged for pitching at least a part of the blade in relation to the rotor about a first axis where the pitch lock system comprises at least a base plate and means for fastening the base plate indirectly to the first bearing ring, and further comprises a locking pawl and means for fastening the locking pawl to the base plate.

2. Description of Related Art

It is well known that wind turbines have some kind of brake or lock system for braking and/or locking the rotor of the turbine in a specific position during repair work or other situations where there is a need for a secure stand still of the rotor. Also, systems for locking the individual blades of a wind turbine in specific positions are known.

German Patent Application DE 10 2004 017 323 A1 teaches a solution to the problem with slack and wear between the parts that are used for pitching a blade for a wind turbine into certain positions. The problem can be solved by using some kind of locking mechanism e.g., a bolt that is placed in a corresponding hole or by having some kind of brake mechanism built into the pitch bearing. Such a brake system can be a disc brake, a magnet brake or a drum brake. By using a bolt lock mechanism, a very simple solution is obtained, but the blade can only be locked in predetermined positions, and thus the solution is somewhat static. By using a brake system, the possibility to position the blade in a very specific position is possible, but installing a brake system is a rather expensive and complex job, and further the system can not provide a foolproof mechanical locking and blocking of the blade.

U.S. Patent Application Publication 2011/0044813 A1 also shows a pitch lock mechanism for locking the pitch bearing system in a fixed position, but this system has the disadvantage that the pitch bearing only can be locked in one or more specific positions, which does not allow for dynamic and free choice of locking position. This system has the same drawbacks as the system discussed above.

European Patent Application EP 1 167 754 A2 concerns a locking mechanism for a wind turbine rotor, where the locking mechanism is integrated into a disc brake system. In one embodiment of the system, the disc is locked in a fixed position by a toothed segment, and in another embodiment the disc can be turned by the locking parts.

A brake or lock system for a pitch bearing construction on a wind turbine is normally arranged between the outer ring and the inner ring of a pitch bearing, which typically is a ball/roller bearing. One of the rings, e.g., the outer ring, will often be fixed to the hub of a wind turbine and the other ring, e.g., the inner ring, will be fixed to the blade. The blade will thus be able to be pitched—turned—about a longitudinal axis of the blade and in relation to the hub/rotor. This movement will often be facilitated by an electro motor and a gear unit or by a hydraulic unit in general called a pitch drive. The unit will normally be acting with a sprocket on a toothed element on the inner ring of the bearing.

A pitch mechanism can also be constructed with a system comprising a hydraulic actuator that is connected to an arm, the system will when activated pitch the rotor blade, and the system will also hold the blade in a specific position and can in some situations be considered as a brake or lock. In case of a power cut off such a system can, due to a pressure accumulator, hold the hydraulic pressure for some time, but if such a system has only a very small leak, the pressure will drop quite rapidly and finally the pitch bearing is no longer locked.

When talking about rotor blades with partial pitch where the pitch bearing is arranged at a distance to the hub, the pitch mechanism experiences very different conditions as when compared to a pitch mechanism installed at the hub. Very often the motors used to perform the pitch movement of the rotor blade are electric motors that comprise a build in brake system that is activated by a mechanical spring system.

In order to overcome these problems, it has been realized that a mechanical lock system that can ensure a rigid fixation of a pitch bearing system in any position is needed.

None of the above mentioned systems show a pitch lock system for a wind turbine that solves the problem of preventing slack in the system and at the same time being a sturdy and robust locking system, comprising a mechanical lock, where the locking position is completely individual, meaning that the pitch bearing construction can be locked in every possible position.

### SUMMARY OF THE INVENTION

It is a primary object of the present invention to provide a pitch lock system for a pitch bearing construction on a wind turbine that provides a mechanical lock, the mechanical lock being possible to activate at every possible position of the pitch bearing construction. Further, it is another object of the invention for the pitch lock system to interact with constructional parts of the pitch bearing construction in order to minimize the need for installing additional parts in the construction. An even further object of the invention is to provide a pitch lock that is suitable for use during service work and/or as a safety solution during extreme wind conditions to spare the pitch drive and its components from any kind of overload.

As mentioned above, the invention relates to a pitch lock system for a wind turbine with a rotor, at least one pitchable blade, or a partial pitch blade, where the blade parts are interconnected at an interface, the interface comprising a pitch bearing system comprising a first bearing ring, a second bearing ring and a pitch drive installed at a support plate at a structural part connected to the first bearing ring, the pitch drive comprising means for interacting with at least two of a number of teeth on a toothed element, where the toothed element is in fixed connection with the second bearing ring, the pitch bearing system being arranged for pitching at least a part of the blade in relation to the rotor about a first axis, where the pitch lock system comprises at least a base plate and means for fastening the base plate indirectly to the first bearing ring, and further comprises a locking pawl and means for fastening the locking pawl to the base plate.

The invention concerns, in particular, that the locking pawl further comprises means for interacting with at least one of the teeth on the toothed element. A pitch lock system according to the invention can be a so called service model that will be used during service work, where the wind speed is less than 20 meters per second. Further, a more extreme model for wind speeds up to approximately 60 meters per second can be used during extreme wind conditions, where there is a need for locking the pitch system in a fixed position. The reason for having a service model for the lower wind speeds is that a pitch lock system according to the invention can be a manual system that is actually installed and used during service and then uninstalled and moved to the next turbine, blade or pitch system that has to be serviced. By designing the pitch lock system to a lower wind speed, the total weight of the parts can be reduced which allows the parts to be carried manually by a service technician to the pitch bearing system.

If a pitch lock system according to the invention is installed permanently, it will most likely be determined to install a heavy duty model, designed to overcome also the extreme conditions. Such a model will have a weight too high for a service technician to carry and will typically be installed together with the rest of the blade in a workshop.

A pitch lock system according to the invention has a base plate that when installed at a pitch bearing system is rotatable about a second axis, the second axis being parallel to the first axis, the base plate further comprising an opening for inserting the locking pawl, the opening being offset from the second axis and having a third axis, where the third axis is parallel to the second axis, where the locking pawl, when installed in the opening, is rotatable about the third axis. Having a rotatable base plate with an offset opening for a rotatable locking pawl gives the benefit of being able to adjust the base plate and the locking pawl in relation to each other and also to adjust the base plate, and thus the locking pawl, in relation to the first bearing ring. In this way, it is possible to adjust the different parts in order to have the locking pawl engaging with the toothed element and thus locking the pitch system in any possible position by fastening the base plate to the first bearing ring and fastening the locking pawl to the base plate. When comparing the invention with the prior art solutions, where e.g., a pawl or bolt has been inserted in aligned recesses or holes in the first and second bearing ring, this is a very easy way of locking a pitch bearing system, especially as there is no need for aligning any locking means in the first and second bearing ring prior to performing a lock. A locking pawl according to the invention will always be able to engage with the toothed element due to the two offset axes, and if there is a need for turning the pitch bearing, it can actually be done by exerting a rotational force on the locking pawl. This will become clearer in the following description and in the drawings.

In an embodiment of a pitch lock system according to the invention, the means for fastening the base plate indirectly to the first bearing ring are arranged to fit a support plate for installing the pitch drive. A pitch lock system according to the invention can thus be installed in any pitch bearing system, either at an unused support plate or by removing a pitch drive. The latter solution is not very attractive, but still possible. Normally, a pitch bearing system will comprise only one support plate for a pitch drive, but a pitch bearing system according to the invention can comprise more than one such support plate and due to the fact that, over time, a pitch drive will wear down the toothed element over a limited number of teeth, it is thus possible to move the pitch drive to another support plate. In order to handle such a situation the pitch drive will be serviced, refurbished or exchanged and installed at another support plate and thus the sprocket at the pitch drive will engage with other teeth on the toothed element. As there normally will be more than one support plate and typically two or four of such support plates, a pitch lock system can easily be installed at one of the support plates. This also means that the parts of the pitch bearing system do not need any change in design or any extra parts to be able to allow a pitch lock system according to the invention to be installed and used.

In a pitch lock system according to the invention, the means on the locking pawl for interacting with the teeth on the toothed element comprises at least one tooth, where the at least one tooth is arranged for engaging between at least two corresponding teeth on the toothed element. By having a locking pawl with at least one tooth that corresponds to the teeth of the toothed element, a simple and easy to use solution is obtained. The toothed element interacts with a corresponding tooth on the locking pawl, and thus all the parts, but the pitch lock system, are the original parts and no changes are needed. All the necessary parts are included in a pitch lock system according to the invention, and all the parts of the pitch bearing system are unchanged standard parts.

In one embodiment of a pitch lock system according to the invention, the means on the locking pawl are constructed with a tooth shape corresponding to the teeth on the toothed element. Thus, it is possible to engage a tooth on the locking pawl between two individual teeth on the toothed part, and when the base plate and the locking pawl is fastened so is the pitch system. A locking pawl can have one, two, three or more teeth, where the teeth are arranged at a certain diameter on the locking pawl, the diameter being less than the diameter of the toothed element e.g., smaller than or equal to the diameter of the sprocket of the pitch drive. The locking pawl can easily have a number of teeth on only a part of its circumference, e.g., on 15, 30 or 45 degrees of the circumference.

In another embodiment of a pitch lock system according to the invention, the means on the locking pawl are constructed with a shape that is complementary to the shape of the teeth on the toothed element. Such a locking pawl will fit more precisely into engagement with the toothed element and will thus be able to withstand higher forces due to a larger contact area between the two parts. For example, a locking pawl with one tooth can be used to bring the pitch bearing system into a perfect relative position and then a locking pawl can be changed to another locking pawl with a complementary shape to one or more teeth on the toothed element.

In yet an embodiment of a pitch lock system according to the invention, the base plate further comprises a fixture for interacting with a crossbar on the locking pawl, where the crossbar comprises means for fixing the crossbar to the fixture and/or to the base plate. By letting the crossbar interact with a fixture on the base plate, it becomes easy to check whether the locking pawl is in a certain position or in the right angle in relation to the base plate. When the crossbar fits in the fixture, it simply is in the right position. To keep the locking pawl in position there can be means such as e.g., a bolt hole in the crossbar, which makes it possible to secure and fixate the crossbar/locking pawl to the base plate, but also other means for fixing the crossbar can be used.

A pitch lock system according to the invention can be a manual pitch lock system, where the system is operated by an operator, but it can also be a system that is operated by a number of actuators that, in principle, perform the same steps as when manually operating the pitch lock system.

A manual pitch lock system, according to the invention, can further comprise a lever, the lever comprising means, e.g., a long hole or a slot, for engaging corresponding means, e.g., a pin and the fixture, on the base plate, the lever further comprising means, e.g., a long hole or a slot, for engaging corresponding means, e.g., a grip, on the locking pawl. Such a lever can be designed to manually turn the base plate as well as the pawl into a desired position in relation to the toothed element. The mentioned means on the base plate are interacting with corresponding means on the lever and the means on the locking pawl are interacting with corresponding means on the lever. Thus, a lever for a manual pitch lock system can be used as a universal tool for adjusting the base plate as well as the locking pawl. This will be described in detail in the following figures.

The invention also relates to a method for locking a pitch bearing system of a wind turbine, using a pitch lock system according to the above description, where the method comprises at least the following steps:
arranging the base plate and fixing the base plate indirectly to the first bearing ring,
positioning an opening in the base plate for a locking pawl in relation to the teeth on the toothed element,
inserting the locking pawl in the opening,
rotating the locking pawl in the opening until a crossbar on the locking pawl engages with a corresponding fixture on the base plate,
fastening and fixing the locking pawl to the base plate,
fastening and fixing the base plate indirectly to the first bearing ring.

The steps mentioned above can be performed manually by, e.g., a service technician, but can also be done automatically by use of actuators and other mechanical means installed to position the different parts in relation to each other, and by means of other or the same actuators to fasten and fixate the base plate and/or the locking pawl. The actuators and mechanical means will in practice carry out the same steps as when a pitch lock system is operated manually.

The method for locking a pitch bearing system according to the invention may further comprise at least one of the following steps:
positioning the base plate by engaging a lever with corresponding means on the base plate and exerting a force on the lever and thus rotating the base plate about an axis,
positioning the inserted locking pawl in the opening by engaging a lever with corresponding means on a locking pawl and exerting a force on the lever and thus rotating the locking pawl about an axis and in relation to the base plate,
engaging a lever with corresponding means on a locking pawl and exerting a force on the lever and thus rotating the locking pawl and the base plate about an axis and in relation to the first bearing ring.
   The lever can be a manual tool used by a service technician, but can also be a part of a mechanical construction that is designed to perform the same operations.

In an embodiment of the invention, the base plate of a pitch lock system can be permanently installed at the pitch system, and a service technician will then only have to bring a locking pawl, a lever and other tools in order to install or activate the pitch lock system. When the pitch lock system is manually operated, the weight of the parts and tools needed becomes very important as all the parts need to be carried from the bottom of the tower to the nacelle and further inside a rotor blade from the root end at the hub and to the pitch bearing system, which can be situated some twenty to thirty meters from the root end of the rotor blade.

The base plate as well as the locking pawl can be fitted with a kind of aiming line allowing the parts to be aligned according to the teeth on the toothed element so that only a minor adjustment will have to be carried out using a lever or other tools. Further, the base plate and the locking pawl can have one or more indicators stating that a full contact between the locking pawl and the toothed element is obtained. Such indicators can, e.g., be marks on the various parts that need to be aligned and checked manually or indicated by an electronic switch or the like.

The invention further comprises a wind turbine comprising at least one pitch lock system as described above where the wind turbine is a two bladed wind turbine.

An embodiment of the invention will now be described, by way of example only, with reference to the accompanying drawings.

### BRIEF DESCRIPTION OF THE DRAWINGS

FIG. 1 is a perspective view of a pitch bearing system comprising a pitch drive and a pitch lock system.

FIG. 2 is a perspective view of a base plate, a locking pawl and a lever.

FIG. 3 is a perspective view of a pitch lock system being adjusted.

FIG. 4 is a perspective view of a fixed and fastened pitch lock system.

FIG. 5 is a perspective view of a locking pawl engaged with the toothed element.

FIG. 6 shows a locking pawl before alignment with the toothed element.

FIG. 7 shows the locking pawl seen in FIG. 6, but aligned as in FIG. 5.

FIG. 8 shows the locking pawl seen in FIGS. 6 and 7, but during alignment.

### DETAILED DESCRIPTION OF THE INVENTION

In the following text, the figures will be described one by one and the different parts and positions seen in the figures will be numbered with the same numbers in the different figures. Not all parts and positions indicated in a specific figure will necessarily be discussed together with that figure.

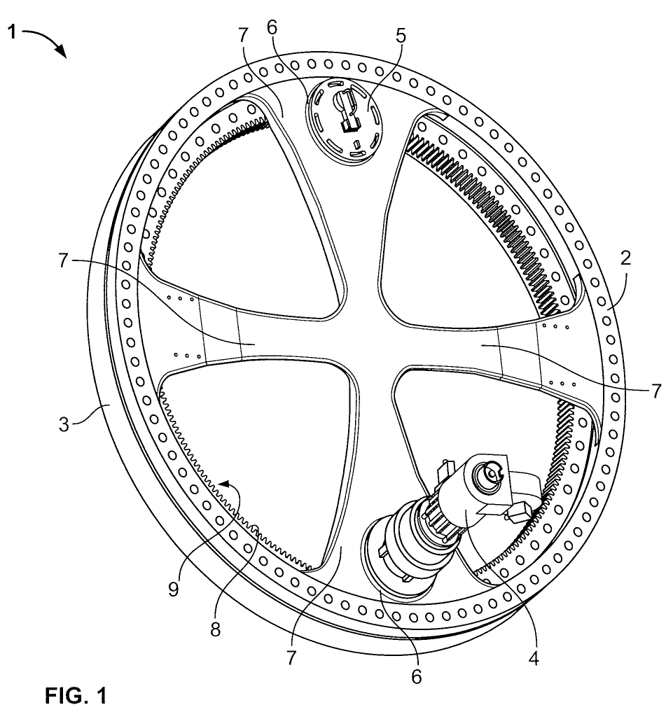

In FIG. 1, a pitch bearing system 1 is seen. The pitch bearing system 1 comprises a first bearing ring 2 and a second bearing ring 3. Between the first and second bearing rings 2, 3, a number of steel balls or rollers are arranged (not shown in the figure). On the first bearing ring 2 there is arranged a pitch drive 4 and a manual pitch lock system 5. The manual pitch lock system 5 is arranged at a support plate 6 corresponding to the support plate 6 that the pitch drive 4 is installed on. A pitch bearing system 1, often or at least sometimes, has two or more of such support plates 6 in order to be redundant when it comes to the possibility of installing a pitch drive 4 in another position due to wear. The support plate 6 can, of course, be different from the support plate for the pitch drive 4. The pitch drive 4 and the pitch lock system 5 are installed on a structural part, stiffener spoke 7 on the first bearing ring 2. Typically the first bearing ring 2 will be fixed to either a hub or a stationary inner blade part and the second bearing ring 3 will be fixed to a rotor blade or to a part of a rotor blade that is operated as a pitch blade. Inside the second bearing ring 3, a number of teeth 8 on a toothed element 9 are seen. The toothed element extends along the entire inner circumference, and the pitch drive 4 has a sprocket that engages with the teeth 8 on the toothed element 9. When the pitch drive 4 is activated, the sprocket is turned, and thus, the toothed element 9 and the second bearing ring 3 will be moved in relation to the first bearing element 2.

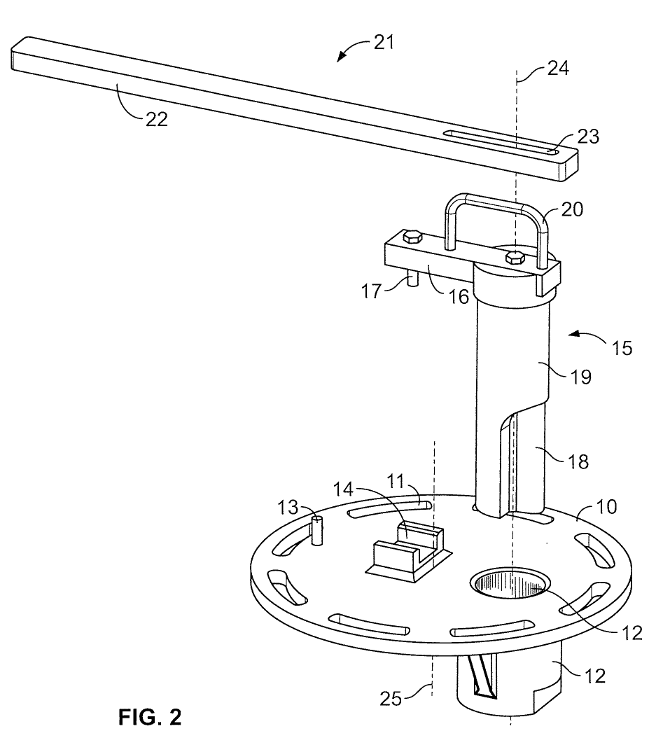

FIG. 2 shows different parts of a pitch lock system 5; in this case, a manual pitch lock system 5, comprising a base plate 10 with long holes 11 along the circumference of the base plate 10, for fastening and fixing the base plate 10 to the support plate 6 on the first bearing ring 2 with bolts that are not shown. The long holes 11 allow for a certain adjustment of the base plate 10 in relation to the support plate 6. Further, the base plate 10 has an opening 12 comprising a guide and support cylinder, a pin 13 and a fixture 14.

The locking pawl 15 is seen in a position above the opening 12 as it will be inserted when used to lock a pitch bearing system 1. The locking pawl 15 has a crossbar 16 that is configured to engage with the mentioned fixture 14 in the base plate 10, and to secure the crossbar 16 in the fixture 14, a threaded safety bolt 17 can be installed through the crossbar 16 and into a threaded hole—not shown—in the base plate 12. The locking pawl 15 is shaped with a tooth 18 for engaging between two teeth 8 on the toothed element 9 and the upper part 19 of the locking pawl 15 is cylindrical and serves as a shaft when the locking pawl 15 is positioned in the opening/guiding and support cylinder 10. On top of the locking pawl 15, there is arranged a grip 20, which can be used during installation and handling but also during adjustment of the locking pawl 15 in relation to the base plate 10.

Further, FIG. 2 shows a lever 21 with a handle 22 at one end and with a long hole or slot 23 in the other end. The long hole 23 is arranged and designed to engage with the grip 20 on the locking pawl 15 in order to turn and adjust the locking pawl 15 about the center axis 24, when installed in the opening 12 in the base plate 10 and when the base plate 10 is fixed to the first bearing ring 2. The lever 21 is further designed to engage with the fixture 14 on the base plate 10 and with the before mentioned pin 13 that is also on the base plate 10. By engaging the lever 21 with the pin 13 and the fixture 14, the base plate 10 can be turned about the axis 25. As the axis 24 and the axis 25 are offset, and as the locking pawl 15 and the base plate 10 can be turned individually, it is possible to position the pitch locking system 5 according to the position of the toothed element 9.

It is actually possible to insert the locking pawl 15 in the opening/guide and support cylinder 12 and turn it into engagement with the fixture 14 on the base plate 10, secure the crossbar 16 in this position and then turn the base plate 10 and the fixed locking pawl 15 as a unit, into the best possible position in relation to the toothed element 9, either by obtaining a relatively good contact between the tooth 18 on the locking pawl 15 and the teeth 8 on the toothed element 9, or by forcing the pitch bearing system to move and to turn into a 100% engagement between the toothed element 9 and the tooth 18 on the locking pawl 15.

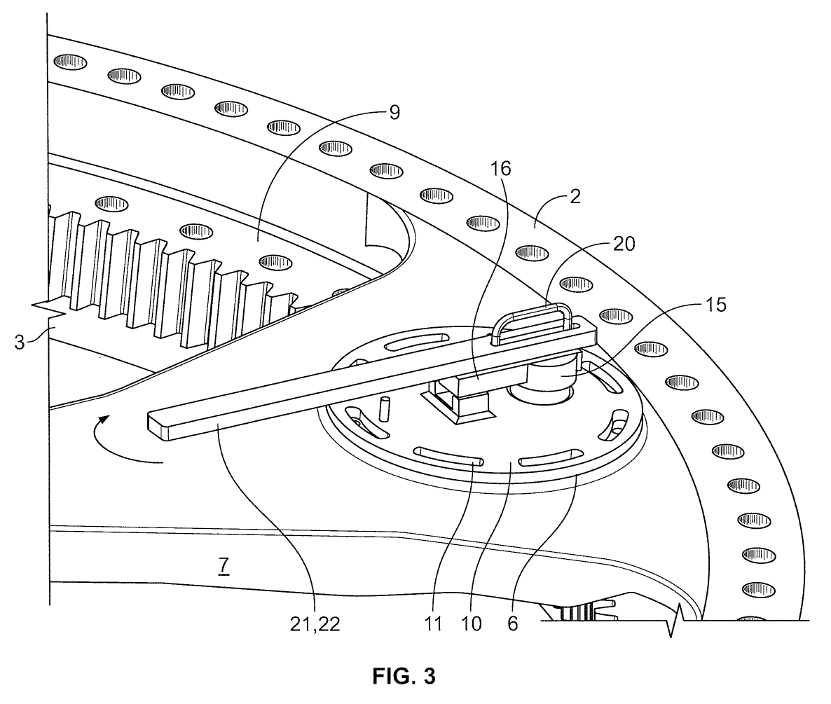

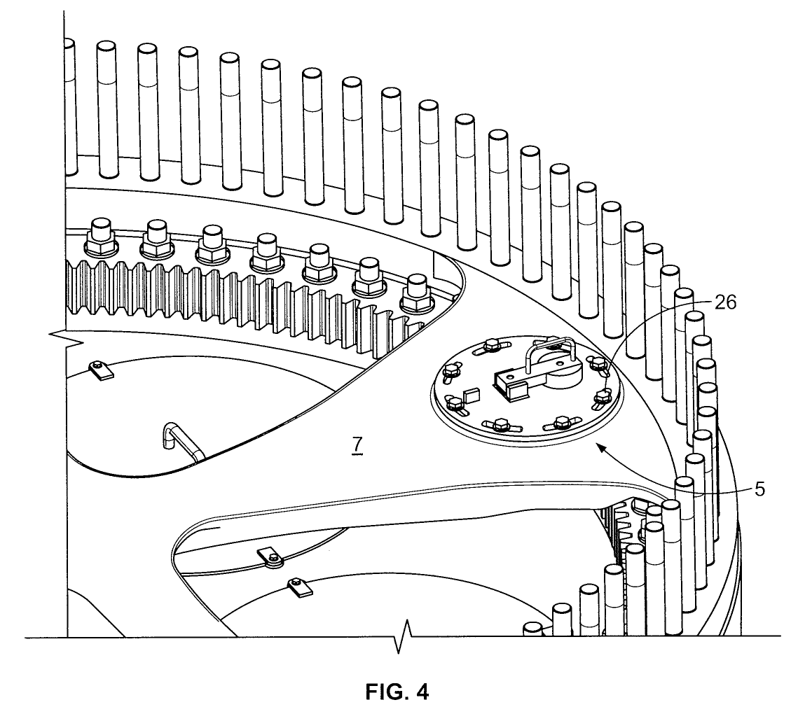

FIG. 3 shows a pitch lock system 5 where a lever 21 is engaged with the grip 20 on the locking pawl 15 in order to adjust the locking pawl 15 in relation to the toothed element 9 on the second bearing ring 3. The base plate 10 is fixed to the structural part 7 of the first bearing ring 2 by bolts 26 (shown only in FIG. 4) in the long holes 11.

FIG. 4 shows a fixed and fastened pitch lock system 5 on a structural part/stiffener spoke 7 on the first bearing ring 2 and here the bolts 26 are seen.

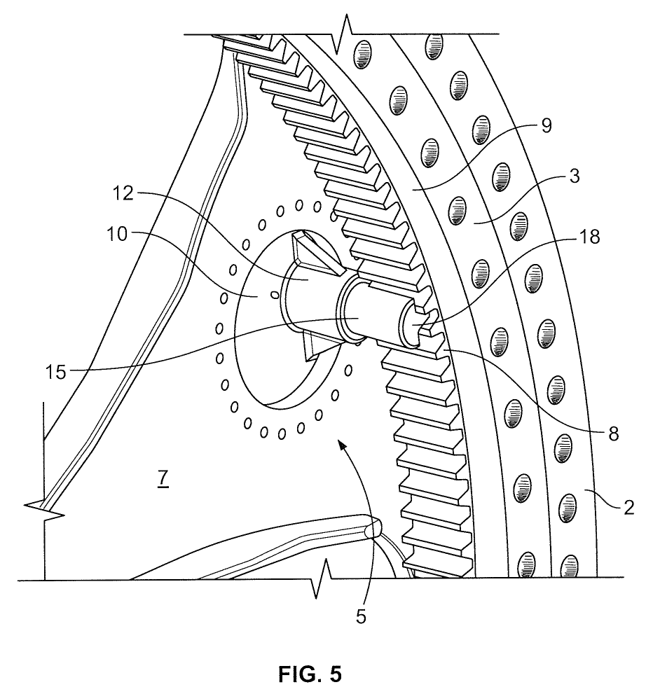

FIG. 5 shows the pitch lock system 5 from underneath, where the locking pawl 15 is engaged with the toothed element 9 on second bearing ring 3. On the structural part 7, a ring of bolt holes is seen that corresponds to the long holes 11 on the base plate 10. The locking pawl 15 has one single tooth 18 with a shape that corresponds to the shape of the teeth 8 on the toothed element 9.

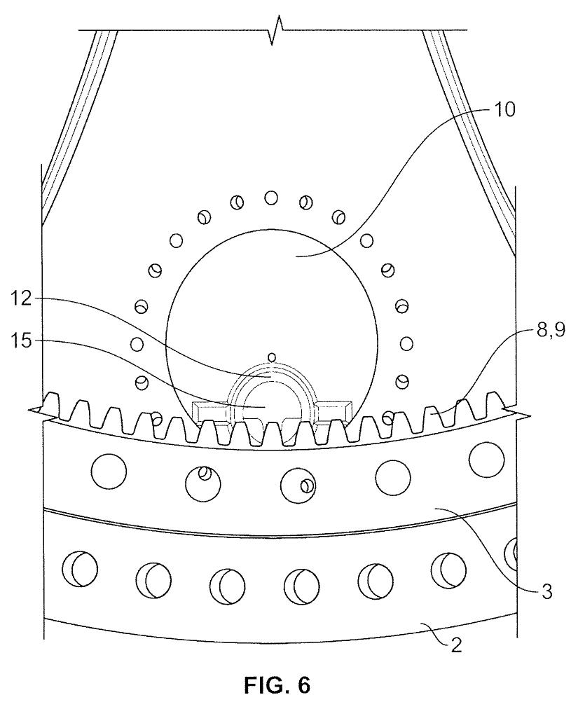

FIG. 6 also shows pitch lock system 5 from below, where locking pawl 15 is positioned above a tooth 8 on the toothed element 9. In order to have the tooth 18 engage with the teeth 8 on the toothed element 9, there is a need for aligning the locking pawl 15 with the toothed element 9. This can be done by rotating the base plate 10 in one direction and by rotating the locking pawl in the opposite direction about their respective axis's 24, 25 in order to offset the tooth 18 on the locking pawl 15, so that it can slide in between two teeth 8 on the toothed element 9.

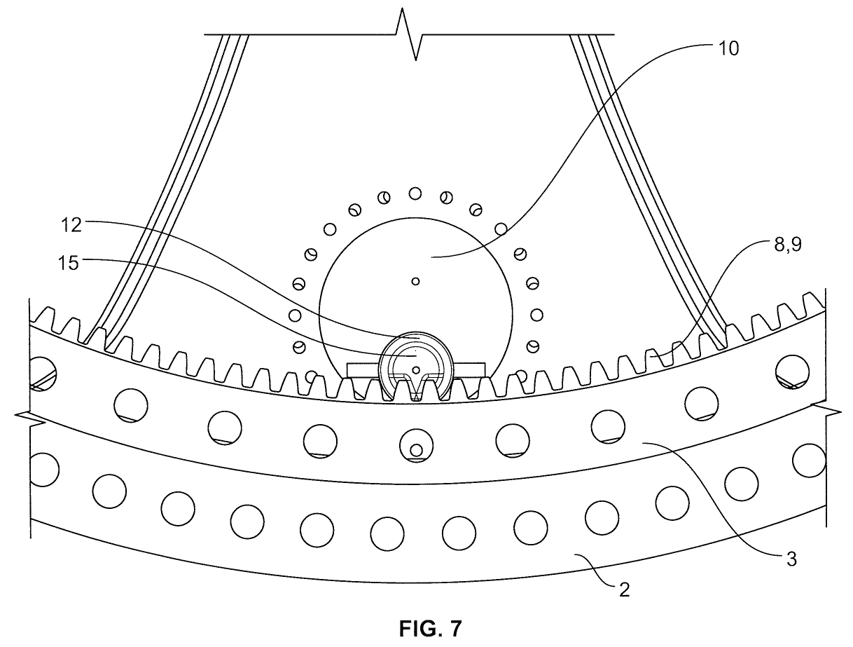

FIG. 7 shows the locking pawl 15 in a fully aligned position with the tooth 18 of the locking pawl 15 in 100% engagement with the teeth 8 as also seen in FIG. 5.

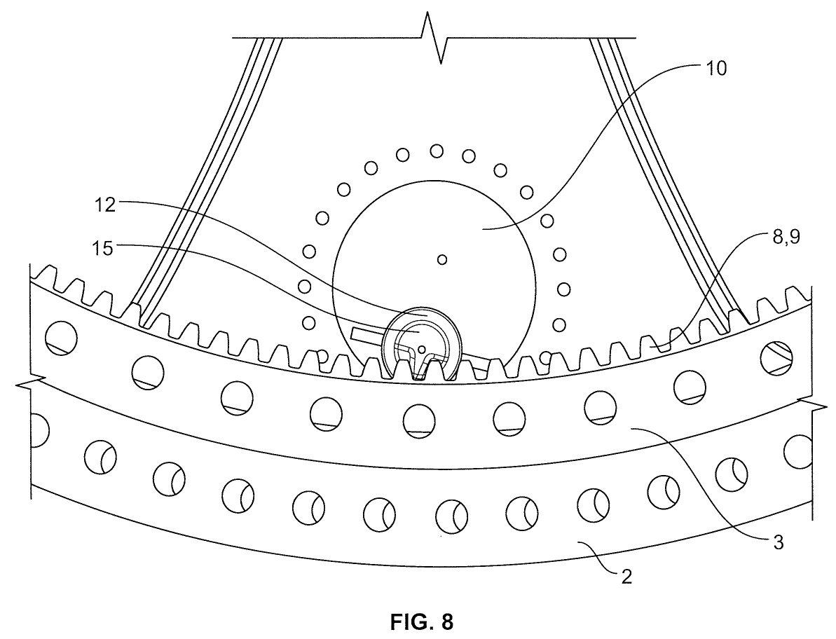

FIG. 8 is a view like those of FIGS. 6 and 7, but during alignment of the locking pawl 15 in relation to the teeth 8.

The invention is not limited to the embodiments described herein, and may be modified or adapted without departing from the scope of the present invention as described in the patent claims below.

What is claimed is:

1. A pitch lock system for a wind turbine with a rotor, the rotor comprising at least one pitchable blade, the at least one pitchable blade being connected to the rotor and comprising an outer blade part and an inner blade part, where the blade parts are interconnected at an interface, the interface comprising a pitch bearing system comprising a first bearing ring, a second bearing ring and a pitch drive, the pitch drive being installed at a support plate on a structural part that connected to the first bearing ring, the pitch drive comprising means for interacting with at least two of a number of teeth on a toothed element, where the toothed element is in fixed connection with the second bearing ring, the pitch bearing system being arranged for pitching at least a part of the blade in relation to the rotor about a first axis, where the pitch lock system comprises”
at least a base plate and
means for fastening the base plate indirectly to the first bearing ring,
a locking pawl and
means for fastening the locking pawl to the base plate,
wherein the locking pawl comprises means for interacting with at least one of the teeth on the toothed element,
wherein the base plate, when installed on a pitch bearing system, is rotatable about a second axis, the second axis being parallel to the first axis, and further comprising an opening for inserting the locking pawl, the opening being offset from the second axis and having a third axis that is parallel to the second axis, and wherein the locking pawl, when installed in the opening, is rotatable about the third axis.

2. A pitch lock system according to claim 1, wherein the means for fastening the base plate indirectly to the first bearing ring are arranged to fit a support plate for installing a pitch drive.

3. A pitch lock system according to claim 1, wherein means for interacting with at least one of the teeth on the toothed element comprises at least one tooth, wherein the at least one tooth is arranged for engaging between at least two corresponding teeth on the toothed element.

4. A pitch lock system according to claim 2, wherein the means for interacting with at least one of the teeth on the toothed element are constructed with a tooth shape corresponding to the shape of the teeth on the toothed element.

5. A pitch lock system according to claim 1, wherein means for interacting with at least one of the teeth on the toothed element have a complementary shape to the shape of the teeth on the toothed element.

6. A pitch lock system according to claim 1, wherein the base plate further comprises a fixture for interacting with a crossbar on the locking pawl, where the crossbar comprises means for fixing the crossbar to at least one of the fixture and the base plate.

7. A pitch lock system according to claim 1, wherein the pitch lock system is a manual pitch lock system that is operable by an operator.

8. A pitch lock system according to claim 7, further comprising a lever, the lever being engageable with a fixture on the base plate and having a long hole or a slot for engaging a grip on the locking pawl.

9. Method for locking a pitch bearing system of a wind turbine that is arranged for pitching at least a part of a turbine blade in relation to a rotor about a first axis, comprising at least the following steps:
arranging and fixing a base plate of a pitch locking system indirectly to a first bearing ring of the pitch bearing system, the base plate being rotatable about a second axis that is parallel to the first axis,
positioning a opening in the base plate for a locking pawl in relation to teeth on a toothed element of a second bearing ring of the pitch bearing system and offset from the second axis,
inserting a locking pawl of pitch locking system in the opening of the base plate,
rotating the locking pawl in the opening rotatable about the third axis until a crossbar on the locking pawl engages with a corresponding fixture on the base plate,
causing an element on the locking pawl to interact with at least one of the teeth on the toothed element of the second bearing ring,
fastening and fixing the locking pawl to the base plate, and
fastening and fixing the base plate indirectly to the first bearing ring.

10. Method for locking a pitch bearing system according to claim 9, wherein the method further comprises at least one of the following steps:
positioning the base plate by engaging a lever with corresponding means on the base plate and exerting a force on the lever and thus rotating the base plate about an axis,
positioning the inserted locking pawl in the opening by engaging a lever with corresponding means on a locking pawl and exerting a force on the lever and thus rotating the locking pawl about an axis and in relation to the base plate,
engaging a lever with corresponding means on a locking pawl and exerting a force on the lever and thus rotating the locking pawl and the base plate in relation to the first bearing ring.
